(19) United States
(12) Patent Application Publication
(10) Pub. No.: US 2022/0207127 A1
(43) Pub. Date: Jun. 30, 2022

(54) CONSOLE-BASED VALIDATION OF SECURE ASSEMBLY AND DELIVERY OF INFORMATION HANDLING SYSTEMS

(71) Applicant: Dell Products, L.P., Round Rock, TX (US)

(72) Inventors: Jason Matthew Young, Round Rock, TX (US); Marshal F. Savage, Austin, TX (US); Mukund P. Khatri, Austin, TX (US)

(73) Assignee: Dell Products, L.P., Round Rock, TX (US)

(21) Appl. No.: 17/138,182

(22) Filed: Dec. 30, 2020

(51) Int. Cl. G06F 21/44; G06F 9/4401; H04L 9/32

(52) U.S. Cl. CPC G06F 21/44; H04L 9/3263; G06F 9/4401

(57) ABSTRACT

Embodiments support remote validation of the secure assembly and delivery of an IHS (Information Handling System). A validation process of the IHS initiates a remote management connection with a remote management console. The remote management console retrieves an inventory certificate generated during factory provisioning of the IHS and stored to the IHS and/or to a remote location. The inventory certificate includes an inventory identifying a plurality of hardware components installed during factory assembly of the IHS. The remote management console retrieves an inventory of detected hardware components of the IHS and compares the inventory of detected hardware components against the inventory from the inventory certificate in order to validate the detected hardware components of the IHS as the same hardware components installed during factory assembly of the IHS.

### FIELD

The present disclosure relates generally to Information Handling Systems (IHSs), and relates more particularly to IHS security.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some types of IHSs, such as mobile phones and tablets, are typically manufactured in large quantities and with few variations. For instance, for a particular model of mobile phone or tablet, hundreds of thousands of identical, or nearly identical, devices may be manufactured. Other types of IHSs, such as rack-mounted servers, are manufactured in much smaller quantities and are frequently manufactured and customized according to specifications provided by a specific customer that has contracted for the manufacture and delivery of the server. In such instances, a customer may specify various hardware and/or software customizations that configure the server to support specific functionality. For example, a customer may contract for manufacture and delivery of a server that includes security adaptations that will enable the server to securely process high volumes of financial transactions. However, such security adaptations may be circumvented by malicious actors by surreptitiously replacing factory installed hardware components of an IHS with compromised hardware components. To a certain extent, IHSs that are mass produced, such as tablets, may be similarly compromised by replacement of factory installed hardware components.

### SUMMARY

Various embodiments provide methods for remote validation of the secure assembly and delivery of an IHS (Information Handling System). The methods may include: initiating, by a validation process of the IHS, a remote management connection with a remote management console; retrieving, by the remote management console, an inventory certificate generated during factory provisioning of the IHS, wherein the inventory certificate includes an inventory identifying a plurality of hardware components installed during factory assembly of the IHS; retrieving, by the remote management console, an inventory of detected hardware components of the IHS; and comparing, by the remote management console, the collected inventory of detected hardware components of the IHS against the inventory from the inventory certificate in order to validate the detected hardware components of the IHS as the same hardware components installed during factory assembly of the IHS.

In additional embodiments, methods may further include comparing, by the remote management console, the inventory included in the inventory certificate against specifications provided for the manufacture of the IHS in order to validate the IHS has been assembled to include specified hardware components. In additional method embodiments, the validation process of the IHS comprises a pre-boot process implemented by a remote access controller of the IHS. In additional method embodiments, the remote management connection with the remote console is automatically initiated by the validation process of the IHS according to instructions uploaded to the IHS during the factory provisioning of the IHS. In additional embodiments, methods may further include confirming, by the remote management console, an integrity of the inventory included in the inventory certificate against a signature included in the inventory certificate. In additional embodiments, methods may further include confirming, by the remote management console, that the validation process of the IHS has access to a private key used to generate the signature. In additional method embodiments, the comparison of the collected inventory of detected hardware components of the IHS against the inventory from the inventory certificate identifies any discrepancies between the detected hardware components of the IHS and the hardware components installed during factory assembly of the IHS. In additional method embodiments, the remote management console supports remote administration of a plurality of IHSs operating within a data center.

Various embodiments provide an IHS that may include: a plurality of hardware components, wherein during factory provisioning of the IHS an inventory certificate is uploaded to the IHS, wherein the inventory certificate includes an inventory that identifies a plurality of hardware components installed during factory assembly of the IHS, and wherein the plurality of hardware components comprise: one or more processors; and one or more memory devices coupled to the processors, the memory devices storing computer-readable instructions that, upon execution by the processors, cause a validation process of the IHS to: initiate a remote management connection with a remote management console; transmit the inventory certificate uploaded to the IHS during factory provisioning of the IHS to the remote management console; and transmit an inventory of the plurality of hardware components of the IHS to the remote management console, wherein the remote management console compares the transmitted inventory of hardware components of the IHS against the inventory from the inventory certificate in order to validate the plurality of hardware components of the IHS as the same hardware components installed during factory assembly of the IHS.

In additional IHS embodiments, the remote management console further compares the inventory included in the inventory certificate against specifications provided for the manufacture of the IHS in order to validate the IHS has been assembled to include specified hardware components. In additional IHS embodiments, the validation process of the IHS comprises a pre-boot process implemented by a remote access controller of the IHS. In additional IHS embodiments, the remote management connection with the remote console is automatically initiated by the validation process of the IHS according to instructions uploaded to the IHS during the factory provisioning of the IHS. In additional IHS embodiments, the remote management console confirms an integrity of the inventory included in the inventory certificate against a signature included in the inventory certificate. In additional IHS embodiments, the remote management console confirms that the validation process of the IHS has access to a private key used to generate the signature. In additional IHS embodiments, the remote management console supports remote administration of a plurality of IHSs operating within a data center.

Various additional embodiments provide systems for remote validation of the secure assembly and delivery of an IHS. The systems may include: the IHS, wherein during factory provisioning of the IHS an inventory certificate is generated includes an inventory that identifies a plurality of hardware components installed during factory assembly of the IHS, and wherein a validation process of the IHS initiates a remote management connection with a remote management console; and the remote management console configured to: retrieve the inventory certificate generated during factory provisioning of the IHS; retrieve, from the IHS, an inventory of detected hardware components of the IHS; and compare the collected inventory of detected hardware components of the IHS against the inventory from the inventory certificate in order to validate the detected hardware components of the IHS as the same hardware components installed during factory assembly of the IHS.

In additional system embodiments, the remote management console is further configured to compare the inventory included in the inventory certificate against specifications provided for the manufacture of the IHS in order to validate the IHS has been assembled to include specified hardware components. In additional system embodiments, the inventory certificate is retrieved from a persistent memory of the IHS or from a remote storage. In additional system embodiments, the remote management connection with the remote console is automatically initiated by the validation process of the IHS according to instructions uploaded to the IHS during the factory provisioning of the IHS. In additional system embodiments, the remote management console supports remote administration of a plurality of IHSs operating within a data center.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a diagram illustrating certain components of a chassis, according to some embodiments, for supporting console-based validation of the secure assembly and delivery of an IHS is installed in the chassis.

FIG. 2 is a diagram illustrating certain components of an IHS configured as a component of a chassis, according to some embodiments, for supporting console-based validation of the secure assembly and delivery of the IHS.

FIG. 3 is a swim lane diagram illustrating certain responsibilities of components of a system configured according to certain embodiments for factory provisioning of an IHS in a manner that supports console-based validation of the secure assembly and delivery of the IHS.

FIG. 4 is a flowchart describing certain steps of a method, according to some embodiments, for assembly and provisioning of an IHS in a manner that supports the console-based validation of the secure assembly and delivery of the IHS.

FIG. 5 is a swim lane diagram illustrating certain responsibilities of components of a system configured according to certain embodiments for console-based validation of the secure assembly and delivery of the IHS.

### DETAILED DESCRIPTION

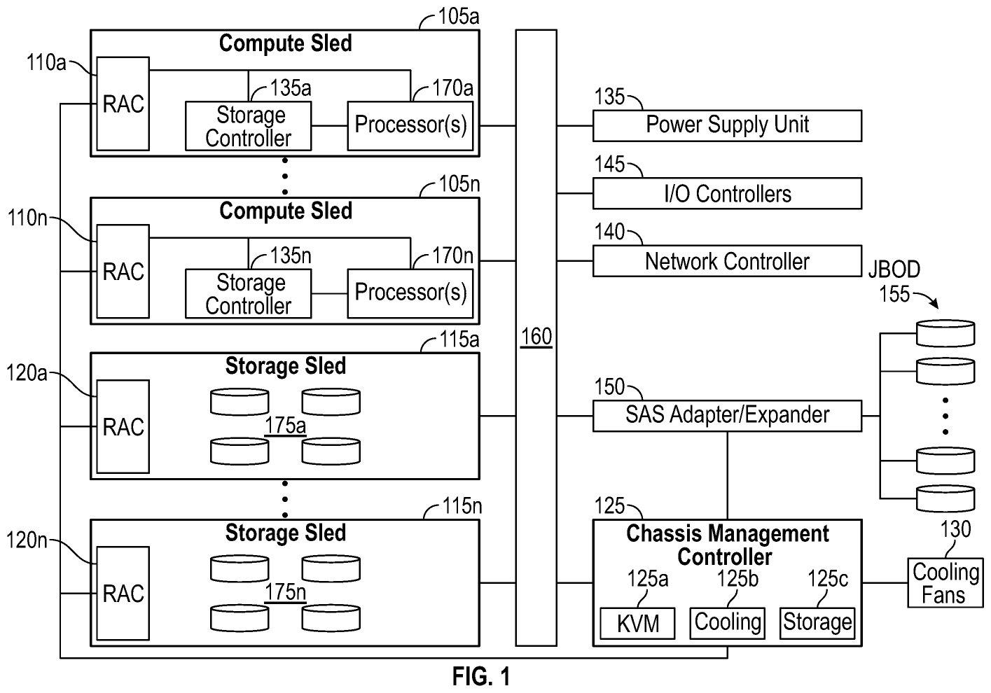

FIG. 1 is a block diagram illustrating certain components of a chassis 100 comprising one or more compute sleds 105a-n and one or more storage sleds 115a-n that may be configured to implement the systems and methods described herein for supporting console-based validation of the secure assembly and delivery of IHS components of the chassis 100. Embodiments of chassis 100 may include a wide variety of different hardware configurations. Such variations in hardware configuration may result from chassis 100 being factory assembled to include components specified by a customer that has contracted for manufacture and delivery of chassis 100. As described in additional detail below, chassis 100 may include capabilities that allow a customer to utilize a remote console in validating that the hardware components of IHSs installed in chassis 100 includes the same components that were installed at the factory during their manufacture.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

Multiple chassis 100 may be housed within a rack. Data centers may utilize large numbers of racks, with various different types of chassis installed in the various configurations of racks. The modular architecture provided by the sleds, chassis and rack allow for certain resources, such as cooling, power and network bandwidth, to be shared by the compute sleds 105a-n and storage sleds 115a-n, thus providing efficiency improvements and supporting greater computational loads.

Chassis 100 may be installed within a rack structure that provides all or part of the cooling utilized by chassis 100. For airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air from within the sleds 105a-n, 115a-n installed within the chassis. A rack and a chassis 100 installed within the rack may utilize various configurations and combinations of cooling fans to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160. In various embodiments, backplane 160 may include various additional components, such as cables, wires, midplanes, backplanes, connectors, expansion slots, and multiplexers. In certain embodiments, backplane 160 may be a motherboard that includes various electronic components installed thereon.

Such components installed on a motherboard backplane 160 may include components that implement all or part of the functions described with regard to the SAS (Serial Attached SCSI) expander 150, I/O controllers 145, network controller 140 and power supply unit 135. In some embodiments, a backplane 160 may be uniquely identified based on a code or other identifier that may be permanently encoded in a non-volatile memory of the backplane 160 by its manufacturer. As described below, embodiments may support remote validation of backplane 160 as being the same backplane that was installed at the factory during the manufacture of chassis 100.

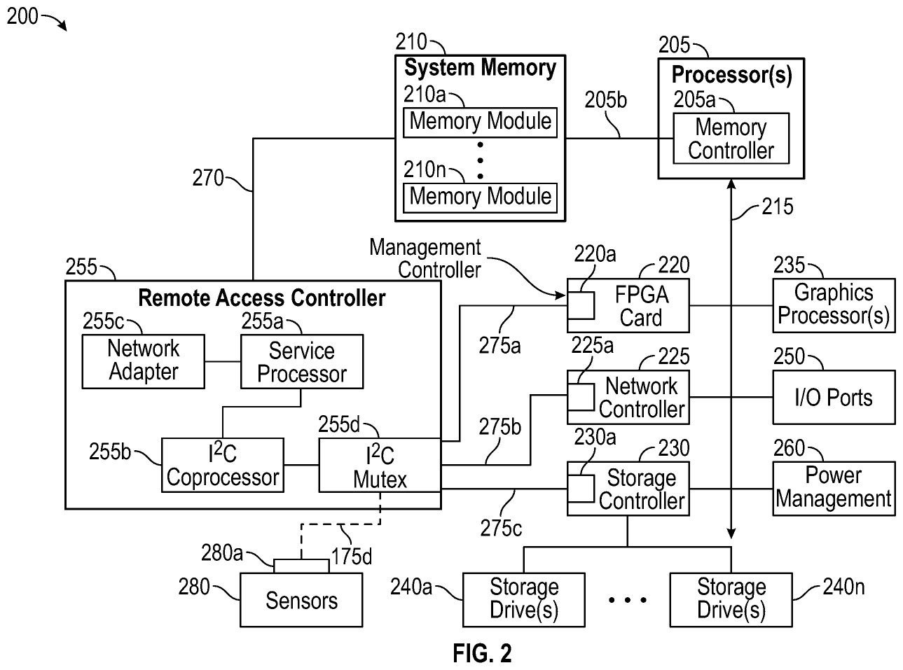

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n are typically configured with hardware and software that provide leading-edge computational capabilities. Accordingly, services provided using such computing capabilities are typically provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications with various components of a compute sled 105a-n and chassis 100. Remote access controllers 110a-n may collect various types of sensor data, such as collecting temperature sensor readings that are used in support of airflow cooling of the chassis 100 and the sleds 105a-n, 115a-n. In addition, each remote access controller 110a-n may implement various monitoring and administrative functions related to compute sleds 105a-n that utilize sideband bus connections with various internal components of the respective compute sleds 105a-n.

In some embodiments, each compute sled 105a-n installed in chassis 100 may be uniquely identified based on a code or other identifier that may be permanently encoded in a non-volatile memory of a respective compute sled 105a-n by its manufacturer. As described below, embodiments support validation of each compute sled 105a-n as being a compute sled that was installed at the factory during the manufacture of chassis 100. Also as described below, during a provisioning phase of the factory assembly of chassis 100, a signed certificate that specifies hardware components of chassis 100 that were installed during its manufacture may be stored in a non-volatile memory that may be accessed by a remote access controller 110a-n of a compute sled 105a-n. Using this signed inventory certificate, a customer may validate that the hardware components of chassis 100 are the same components that were installed at the factory during its manufacture. As described in further detail below, in various embodiments, the remote access controller 110a-n may support remote validation of the hardware components of a compute sled 105a-n and to additionally validate that a compute sled 105a-n that has been delivered and installed in chassis 100 is the compute sled 105 that was ordered by a customer for installation in this particular chassis 100. In a data center environment, compute sleds 105a-n may be regularly delivered for installation in one of the many rack-mounted chassis that may be utilized within a data center. Each compute sled received at a data center may be manufactured according to specifications that adapt the compute sled for a particular computing solution, such as for computationally intensive artificial intelligence applications or for supporting streaming multimedia applications. In a data center environment that may house large numbers of chassis, received compute sleds 105a-n can be inadvertently installed in the wrong chassis 100. Embodiments provide administrators with tools to ensure that a compute sled 105a-n installed in chassis 100 has been delivered with the hardware configuration that was ordered for that compute sled and that the hardware components included in the compute sled 105a-n have not been compromised since the compute sled was manufactured. Embodiments may further provide administrators for ensuring the correct compute sled 105a-n has been installed in a particular chassis 100.

Each of the compute sleds 105a-n may include a storage controller 135a-n that may be utilized to access storage drives that are accessible via chassis 100. Some of the individual storage controllers 135a-n may provide support for RAID (Redundant Array of Independent Disks) configurations of logical and physical storage drives, such as storage drives provided by storage sleds 115a-n. In some embodiments, some or all of the individual storage controllers 135a-n may be HBAs (Host Bus Adapters) that provide more limited capabilities in accessing physical storage drives provided via storage sleds 115a-n and/or via SAS expander 150.

In addition to the data storage capabilities provided by storage sleds 115a-n, chassis 100 may provide access to other storage resources that may be installed components of chassis 100 and/or may be installed elsewhere within a rack housing the chassis 100, such as within a storage blade. In certain scenarios, such storage resources 155 may be accessed via a SAS expander 150 that is coupled to the backplane 160 of the chassis 100. The SAS expander 150 may support connections to a number of JBOD (Just a Bunch Of Disks) storage drives 155 that may be configured and managed individually and without implementing data redundancy across the various drives 155. The additional storage resources 155 may also be at various other locations within a datacenter in which chassis 100 is installed. Such additional storage resources 155 may also be remotely located. In some embodiments, a SAS expander 150 and storage drives 155 may each be uniquely identified based on a code or other identifier that may be permanently encoded in a non-volatile memory of the SAS expander or storage drive by its respective manufacturer. In instances where SAS expander 150 and storage drives 155 are factory installed, as described below, embodiments may support remote validation of SAS expander 150 and storage drives 155 as being the same SAS expander and storage drives that were installed at the factory during the manufacture of chassis 100.

As illustrated, chassis 100 also includes one or more storage sleds 115a-n that are coupled to the backplane 160 and installed within one or more bays of chassis 200 in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. The storage sleds 115a-n may be utilized in various storage configurations by the compute sleds 105a-n that are coupled to chassis 100. As illustrated, each storage sled 115a-n includes a remote access controller (RAC) 120a-n provides capabilities for remote monitoring and management of respective storage sleds 115a-n. In some embodiments, each storage sled 115a-n may be uniquely identified based on a code or other identifier that may be permanently encoded in a non-volatile memory of the respective storage sled 115a-n by its manufacturer. As described below, embodiments support remote validation of each storage sled 115a-n as being a storage sled that was installed at the factory during the manufacture of chassis 100.

As illustrated, the chassis 100 of FIG. 1 includes a network controller 140 that provides network access to the sleds 105a-n, 115a-n installed within the chassis. Network controller 140 may include various switches, adapters, controllers and couplings used to connect chassis 100 to a network, either directly or via additional networking components and connections provided via a rack in which chassis 100 is installed. In some embodiments, a network controller 140 may be uniquely identified based on a code or other identifier that may be permanently encoded in a non-volatile memory of the network controller 140 by its manufacturer. As described below, embodiments support remote validation of network controller 140 as being the same network controller that was installed at the factory during the manufacture of chassis 100.

Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units. In some embodiments, a power supply unit 135 may be uniquely identified based on a code or other identifier that may be permanently encoded in a non-volatile memory of the power supply unit 135 by its manufacturer. As described below, embodiments support remote validation of power supply unit 135 as being the same power supply unit that was installed at the factory during the manufacture of chassis 100.

Chassis 100 may also include various I/O controllers 140 that may support various I/O ports, such as USB ports that may be used to support keyboard and mouse inputs and/or video display capabilities. Such I/O controllers 145 may be utilized by the chassis management controller 125 to support various KVM (Keyboard, Video and Mouse) 125a capabilities that provide administrators with the ability to interface with the chassis 100. In some embodiments, each I/O controller 140 may be uniquely identified based on a code or other identifier that may be permanently encoded in a non-volatile memory of the respective I/O controller 140 by its manufacturer. As described below, embodiments support remote validation of I/O controllers 140 as being the same I/O controllers that were installed at the factory during the manufacture of chassis 100.

The chassis management controller 125 may also include a storage module 125c that provides capabilities for managing and configuring certain aspects of the storage devices of chassis 100, such as the storage devices provided within storage sleds 115a-n and within the JBOD 155. In some embodiments, a chassis management controller 125 may be uniquely identified based on a code or other identifier that may be permanently encoded in a non-volatile memory of the chassis management controller 125 by its manufacturer. As described below, embodiments support remote validation of chassis management controller 125 as being the same chassis management controller that was installed at the factory during the manufacture of chassis 100.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power 135, network bandwidth 140 and airflow cooling 130 that are available via the chassis 100. As described, the airflow cooling 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for supporting console-based validation of the secure assembly and delivery of the IHS 200. It should be appreciated that although the embodiments described herein may describe an IHS that is a compute sled or similar computing component that may be deployed within the bays of a chassis, other embodiments may be implemented via other types of IHSs that may also support console-based validation of the secure assembly and delivery of the IHS 200. In the illustrative embodiment of FIG. 2, IHS 200 may be a computing component, such as compute sled 105a-n or other type of server, such as an 1RU server installed within a 2RU chassis, that is configured to share infrastructure resources provided by a chassis 100.

The IHS 200 of FIG. 2 may be a compute sled, such as compute sleds 105a-n of FIG. 1, that may be installed within a chassis, that may in turn be installed within a rack. Installed in this manner, IHS 200 may utilize shared power, network and cooling resources provided by the chassis and/or rack. Embodiments of IHS 200 may include a wide variety of different hardware configurations. Such variations in hardware configuration may result from IHS 200 being factory assembled to include components specified by a customer that has contracted for manufacture and delivery of IHS 200. As described in additional detail below, IHS 200 may include capabilities that allow a customer to remotely validate that the hardware components of IHS 200 are the same hardware components that were installed at the factory during its manufacture. In addition, the capabilities of IHS 200 may further support validation that IHS 200 has been assembled according to the customer's specifications, thus ensuring that IHS 200 has been correctly configured to support a specific computing solution.

IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications. In some embodiments, each of the processors 205 may be uniquely identified based on a code or other identifier that may be permanently encoded in a respective processor 205 by its manufacturer. As described below, embodiments support validation of processors 205 as being the same processors that were installed at the factory during the manufacture of IHS 200. Embodiments may also support remote validation that a motherboard on which processor 205 is mounted is the same motherboard that was installed during factory assembly of IHS 200.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b. The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory. In some embodiments, each of the memory modules 210a-n may be uniquely identified based on a code or other identifier that may be permanently encoded in a respective memory module 210a-n by its manufacturer. As described below, embodiments support remote validation of memory modules 210a-n as being the same memory modules that were installed at the factory during the manufacture of IHS 200.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources and/or other peripheral components.

As illustrated, IHS 200 may include one or more FPGA (Field-Programmable Gate Array) cards 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of such logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a. In some embodiments, each of the FPGA cards 220 installed in IHS 200 may be uniquely identified based on a code or other identifier that may be permanently encoded in the FPGA card 220 by its manufacturer. As described below, embodiments support remote validation of FPGA card 220 as being the same FPGA card that was installed at the factory during the manufacture of IHS 200.

Processor(s) 205 may also be coupled to a network controller 225 via in-band bus 215, such as provided by a Network Interface Controller (NIC) that allows the IHS 200 to communicate via an external network, such as the Internet or a LAN. In some embodiments, network controller 225 may be a replaceable expansion card or adapter that is coupled to a motherboard connector of IHS 200. In some embodiments, network controller 225 may be an integrated component of IHS 200. In some embodiments, network controller 225 may be uniquely identified based on a code or other identifier, such as a MAC address, that may be permanently encoded in a non-volatile memory of network controller 225 by its manufacturer. As described below, embodiments support remote validation of network controller 225 as being the same network controller that was installed at the factory during the manufacture of IHS 200.

IHS 200 may include one or more storage controllers 230 that may be utilized to access storage drives 240a-n that are accessible via the chassis in which IHS 200 is installed. Storage controllers 230 may provide support for RAID (Redundant Array of Independent Disks) configurations of logical and physical storage drives 240a-n. In some embodiments, storage controller 230 may be an HBA (Host Bus Adapter) that provides more limited capabilities in accessing physical storage drives 240a-n. In some embodiments, storage drives 240a-n may be replaceable, hot-swappable storage devices that are installed within bays provided by the chassis in which IHS 200 is installed. In some embodiments, storage drives 240a-n may also be accessed by other IHSs that are also installed within the same chassis as IHS 200. Although a single storage controller 230 is illustrated in FIG. 2, IHS 200 may include multiple storage controllers that may operate similarly to storage controller 230. In embodiments where storage drives 240a-n are hot-swappable devices that are received by bays of chassis, the storage drives 240a-n may be coupled to IHS 200 via couplings between the bays of the chassis and a midplane or backplane 245 of IHS 200. Storage drives 240a-n may include SAS (Serial Attached SCSI) magnetic disk drives, SATA (Serial Advanced Technology Attachment) magnetic disk drives, solid-state drives (SSDs) and other types of storage drives in various combinations. In some embodiments, storage controllers 230 and storage drives 240a-n may each be uniquely identified based on a code or other identifier that may be permanently encoded in a non-volatile memory of these devices by their respective manufacturers. As described below, embodiments support remote validation of storage controllers 230 and storage drives 240a-n as being the same components that were installed at the factory during the manufacture of IHS 200.

A variety of additional components may be coupled to processor(s) 205 via in-band bus 215. For instance, processor(s) 205 may also be coupled to a power management unit 260 that may interface with the power system unit 135 of the chassis 100 in which an IHS, such as a compute sled, may be installed. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255. In some embodiments, components such as power management unit 260 and graphics processor 235 may also be uniquely identified based on a code or other identifier that may be permanently encoded in a non-volatile memory of these components by their respective manufacturer. As described below, embodiments support remote validation of these components as being components that were installed at the factory during the manufacture of IHS 200.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255. As described in additional detail below, in some embodiments, BIOS may be configured to identify hardware components that are detected as being currently installed in IHS 200. In such instances, the BIOS may support queries that provide the described unique identifiers that have been associated with each of these detected hardware components by their respective manufacturers.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As described, IHS 200 may include a remote access controller 255 that supports remote management of IHS 200 and of various internal components of IHS 200. In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the operating system of IHS 200 (i.e., in a bare-metal state). In some embodiments, certain operations of the remote access controller 225, such as the described inventory certificate generation and validation operations, may operate using validated instructions, and thus within the root of trust of IHS 200.

In some embodiments, remote access controller 255 may be uniquely identified based on a code or other identifier that may be permanently encoded in a non-volatile memory of the remote access controller 255 by its manufacturer. As described below, embodiments support remote validation of remote access controller 255 as being the same controller that was installed at the factory during the manufacture of IHS 200. Also as described below, during a provisioning phase of the factory assembly of IHS 200, a signed certificate that specifies factory installed hardware components of IHS 200 that were installed during manufacture of the IHS 200 may be stored in a non-volatile memory that is accessed by remote access controller 255. Using this signed inventory certificate stored by the remote access controller 255, a customer may remotely validate that the detected hardware components of IHS 200 are the same hardware components that were installed at the factory during manufacture of IHS 200.

In support of the capabilities for validating the detected hardware components of IHS 200 against the inventory information that is specified in a signed inventory certificate, remote access controller 255 may support various cryptographic capabilities. For instance, remote access controller 255 may include capabilities for key generation such that remote access controller may generate keypairs that include a public key and a corresponding private key. As described in additional detail below, using generated keypairs, remote access controller 255 may digitally sign inventory information collected during the factory assembly of IHS 200 such that the integrity of this signed inventory information may be validated at a later time using the public key by a customer that has purchased IHS 200. Using these cryptographic capabilities of the remote access controller, the factory installed inventory information that is included in an inventory certificate may be anchored to a specific remote access controller 255, since the keypair used to sign the inventory information is signed using the private key that is generated and maintained by the remote access controller 255.

In some embodiment, the cryptographic capabilities of remote access controller 255 may also include safeguards for encrypting any private keys that are generated by the remote access controller and further anchoring them to components within the root of trust of IHS 200. For instance, a remote access controller 255 may include capabilities for accessing hardware root key (HRK) capabilities of IHS 200, such as for encrypting the private key of the keypair generated by the remote access controller. In some embodiments, the HRK may include a root key that is programmed into a fuse bank, or other immutable memory such as one-time programmable registers, during factory provisioning of IHS 200. The root key may be provided by a factory certificate authority, such as described below. By encrypting a private key using the hardware root key of IHS 200, the hardware inventory information that is signed using this private key is further anchored to the root of trust of IHS 200. If a root of trust cannot be established through validation of the remote access controller cryptographic functions that are used to access the hardware root key, the private key used to sign inventory information cannot be retrieved. In some embodiments, the private key that is encrypted by the remote access controller using the HRK may be stored to a replay protected memory block (RPMB) that is accessed using security protocols that require all commands accessing the RPMB to be digitally signed using a symmetric key and that include a nonce or other such value that prevents use of commands in replay attacks. Stored to an RPMG, the encrypted private key can only be retrieved by a component within the root of trust of IHS 200, such as the remote access controller 255.

As described in additional detail with regard to FIG. 7, remote access controller 255 may be additionally configured with various capabilities in support of remote validation of the hardware component of IHS 200. As described, remote access controller 255 may operate from a separate power plane from the processor 205 and from many other components of the IHS 200 such that remote access controller 255 may operate independent from the operating system of IHS 200. Using such capabilities, remote access controller 255 may support provisioning of IHS 200 without further booting of IHS 200, where such provisioning may include the described factory provisioning of IHS 200 and may also include customer provisioning of IHS 200 after the IHS has been delivered and is being prepared for deployment, such as within a datacenter. In support of such customer provisioning, remote access controller 255 may be configured with instructions for automatically initiating procedures for remote management of IHS 200 upon IHS 200 being initialized for the first time by a customer. For instance, remote access controller 255 may automatically connect with a designated server that provides the remote access controller 255 with scripts for use in configuring the IHS 200 for remote management by management tools utilized by the customer. Once configured for operation using remote management tools utilized by the customer, remote access controller 255 may be further configured to initiate discovery of IHS 200 by these remote management tools. In this manner, remote access controller 255 automatically establishes a connection with the customer's remote management tools without the customer having to provide any administration of IHS 200 beyond installing and powering the IHS. With a connection established between remote access controller 255 and the customer's remote management tools, remote access controller 255 may be further configured to utilize a remote management interface that is supported by these remote management tools in order to support remote validation of the hardware components of IHS 200.

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies. As a non-limiting example of a remote access controller, the integrated Dell Remote Access Controller (iDRAC) from Dell® is embedded within Dell PowerEdge™ servers and provides functionality that helps information technology (IT) administrators deploy, update, monitor, and maintain servers remotely.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as non-standard hardware 220, network controller 225 and storage controller 230, are coupled to the IHS processor(s) 205 via an in-line bus 215, such as a PCIe root complex, that is separate from the I2C sideband bus connections 275a-d used for device management. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280. In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

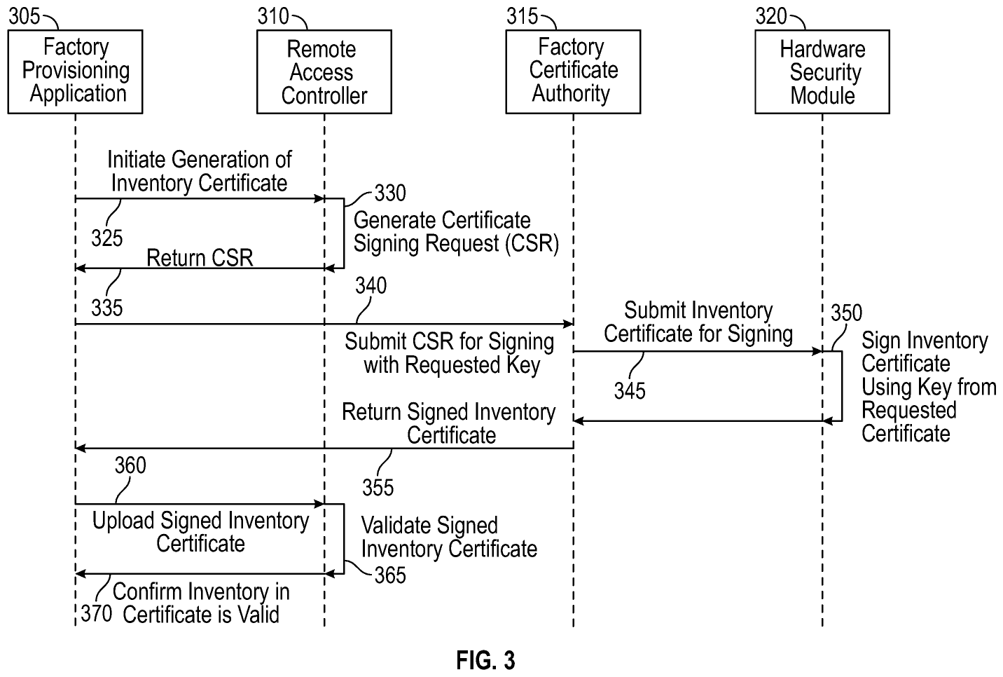

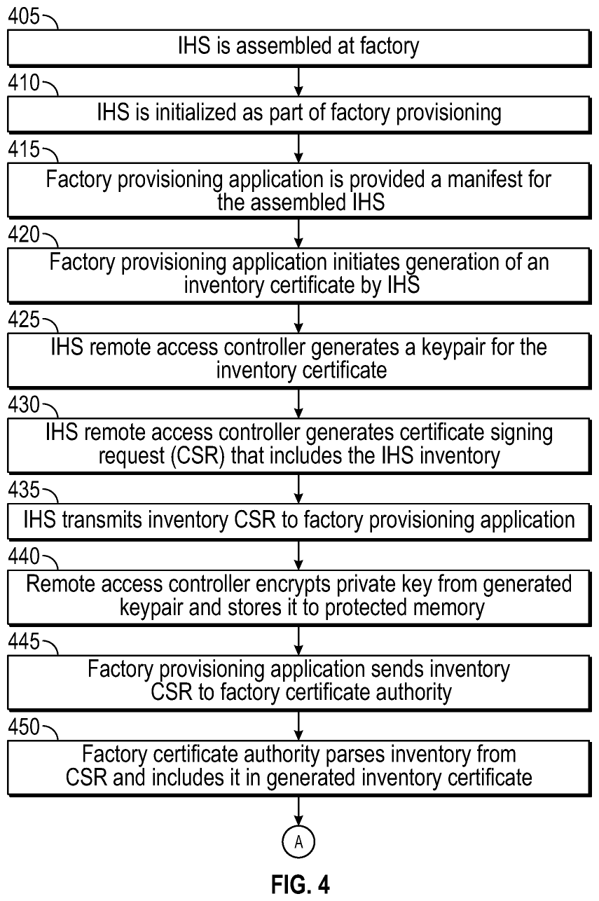

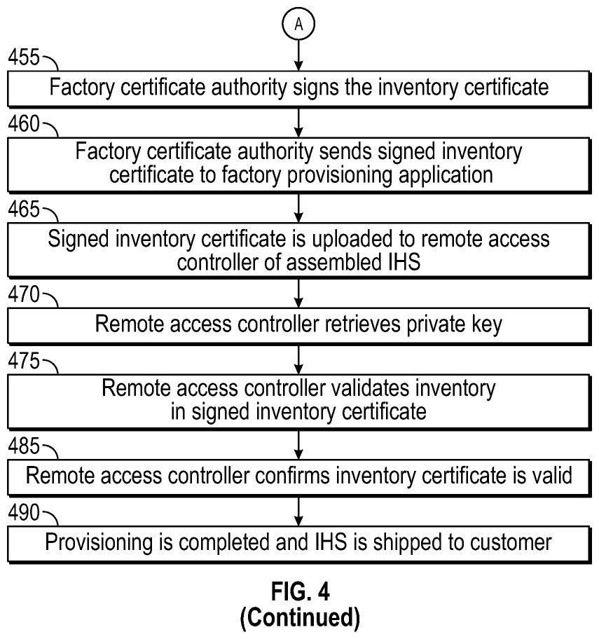

FIG. 3 is a swim lane diagram illustrating certain responsibilities of components of a system configured according to certain embodiments for factory provisioning of an IHS in a manner that supports console-based validation of the secure assembly and delivery of the IHS. FIG. 4 is a flowchart describing certain steps of a method, according to some embodiments, for assembly and provisioning of an IHS in a manner that supports the console-based validation of the secure assembly and delivery of the IHS. Some embodiments of the method of FIG. 4 may begin, at block 405, with the factory assembly of an IHS, such as the assembly of a server described with regard to FIGS. 1 and 2. In some instances, an IHS may be manufactured using a factory process that includes multiple phases of assembly, validation and provisioning that must be completed before the IHS is shipped to a customer. An IHS such as a server may be purpose-built for a particular customer such that the server is assembled and provisioned according to specifications provided by the customer. As described below, in some embodiments, a customer that contracts for manufacture of an IHS may provide various specifications for the hardware components that are to be installed in the IHS. The customer may retain these specifications in a manner that may be utilized, in some embodiments, to remotely validate that a delivered IHS has been manufactured for the customer according to their provided specifications. In some embodiments, the customer may retain these specifications for ordered IHSs in a data center management system that may include capabilities for tracking the hardware configurations of IHSs that have been ordered, as well as tracking the hardware configurations of these IHSs once they have been deployed. The initial factory assembly of an IHS, such as a server for use in a data center, may include the selection of a chassis and the fastening of various hardware components to the selected chassis. Such a factory assembly process may include generating a manifest that tracks the individual hardware components that are installed in an IHS. As described above, the installed hardware components may include standard components and may also include specialized components that have been requested by a specific customer that has contracted for the assembly and delivery of an IHS.

Once the assembly of an IHS has been completed, the IHS may be subjected to manual and automated inspections that confirm the IHS has been properly assembled and does not include any defects. After confirming an IHS has been assembled without any manufacturing defects, at block 410, factory provisioning of the IHS may be initiated. In some instances, the provisioning of an IHS at the factory may include various stages that may include stages for loading of firmware, configuring hardware components, and installing an operating system and other software. As indicated in FIG. 3, various aspects of this factory provisioning process may be conducted using a factory provisioning application, where this factory provisioning application may run on one or more servers and may interface with an IHS that is being provisioned once a requisite amount of firmware and software has been installed to the IHS.

As described, a manifest of the individual hardware components that are installed in an IHS may be generated during assembly of the IHS. Such a manifest may be a file that includes an entry for each component installed to an IHS, where the entry may specify various characteristics of the component, such as model numbers and installation locations, and may also specify any unique identifiers associated with the component, such as a MAC address or a serial number. At block 415, a manifest generated during assembly of an IHS is provided to the factory provisioning application that is being used to provision the assembled IHS. Based on this hardware manifest information, at block 420, the factory provisioning application may also initiate the generation of an inventory certificate that may be used to remotely validate that the detected hardware components of the IHS are the same hardware components that were installed during the factory assembly of the IHS.

As described with regard to FIGS. 1 and 2, an IHS may include a remote access controller that provides capabilities for remote management of an IHS, where these remote management capabilities may include sideband management of various hardware components of an IHS. As indicated in FIG. 3, the generation of an inventory certificate for a newly assembled IHS, at 325, may be initiated via a request from the factory provisioning application 305 to the remote access controller 310 of the IHS. As described with regard to FIG. 2, a remote access controller of an IHS may include cryptographic capabilities that operate within the root of trust of the IHS and that include the ability to generate cryptographic keypairs. Utilizing such cryptographic capabilities, at block 425, the remote access controller 310 initiates the generation of an inventory certificate by generating a cryptographic key pair for use in validating the authenticity of inventory information that is included in an inventory certificate and that describes the factory installed hardware components of the IHS.

At block 430 and at 330, the remote access controller 310 generates a certificate signing request (CSR) for a digital identity certificate, where the request specifies the public key of the key pair generated by the remote access controller and also specifies the factory installed hardware inventory from the manifest that was generated during assembly of the IHS. The factory installed hardware inventory information included in the CSR may be signed by the remote access controller using the private key from the generated keypair. At block 435 and at 335, the CSR for the requested inventory certificate is transmitted to the factory provisioning application 305 by the remote access controller 310. At block 440, the remote access controller safeguards the private key from the generated key pair. In some embodiments, the remote access controller may encrypt the private key using the hardware root key (HRK) of the IHS and may store the encrypted key to a protected memory, such as the replay protected memory block that is described with regard to FIG. 2.

Upon receiving the certificate signing request from the remote access controller 310, at block 445 and at 340, the factory provisioning application 305 submits the CSR for signing by a factory certificate authority 315. In some embodiments, the factory provisioning application 305 specifies a factory key to be used by the factory certificate authority 315 in signing the inventory certificate. For instance, the factory provisioning application may include the name of a trusted certificate associated with a factory key as an attribute of the CSR that is transmitted to the factory certificate authority 315. Upon receipt of the CSR, at block 450, the factory certificate authority parses from the CSR: the hardware inventory information, the public key generated by the remote access controller and the information specifying the requested signing key. Based on the information parsed from the CSR, the factory certificate authority generates a digital identity certificate, referred to herein as an inventory certificate, that is associated with the public key provided by the remote access controller and that specifies the factory installed hardware inventory of the IHS.

As indicated in FIG. 3, at 345, the factory certificate authority 315 submits the generated inventory certificate for signing by a hardware security module 320 that may be a dedicated hardware component of a factory provisioning server that safeguards cryptographic keys and implements cryptographic functions utilized in the factory provisioning process. In some embodiments, the factory certificate authority 315 may also specify a certificate name associated with a signing key that is maintained by the hardware security module 320. At 350, the hardware security module 320 utilizes the private key associated with the specified certificate in order to digitally sign the submitted inventory certificate, which includes the inventory of the factory installed hardware components of the IHS. The signed inventory certificate is then returned to the factory certificate authority 315 by the hardware security module 320.

At block 460 and at 355, the signed inventory certificate is transmitted from the factory certificate authority 315 to the factory provisioning application 305. At block 465 and at 360, the signed inventory certificate is than loaded to the assembled IHS. As indicated in FIG. 3, in some embodiments, the signed inventory certificate may be uploaded to a remote access controller 310 of the assembled IHS, such that the signed inventory certificate may be stored to a nonvolatile memory or other persistent storage that is accessible by the remote access controller 310 independent from the operating system of the IHS. In other embodiments, the signed inventory certificate may be uploaded without reliance on the remote access controller to another non-volatile memory of the IHS. In some embodiments, the inventory certificate may be additionally or alternatively stored for use in providing ongoing support of the IHS, such as in a data repository that is accessible by a trusted entity providing ongoing support of the IHS.

Some embodiments may continue, at 365, with the validation of the signed inventory certificate by the remote access controller 310. Using the public key from the generated keypair, at block 475, the remote access controller decrypts the signature included by the remote access controller in the CSR and confirms that the inventory information included in the signed inventory certificate matches the inventory information that was submitted in the certificate signing request, thus validating the integrity of the generation of the signed inventory certificate. At block 485, the remote access controller confirms that the inventory included in the signed inventory certificate is valid and, at 370, the remote access controller 310 confirms the validity of the inventory certificate with a notification to the factory provisioning application 305. With the generation and validation of the signed inventory certificate completed, additional factory provisioning of the assembled IHS may be completed and, at block 490, the assembled IHS may be shipped from the factory to a customer.

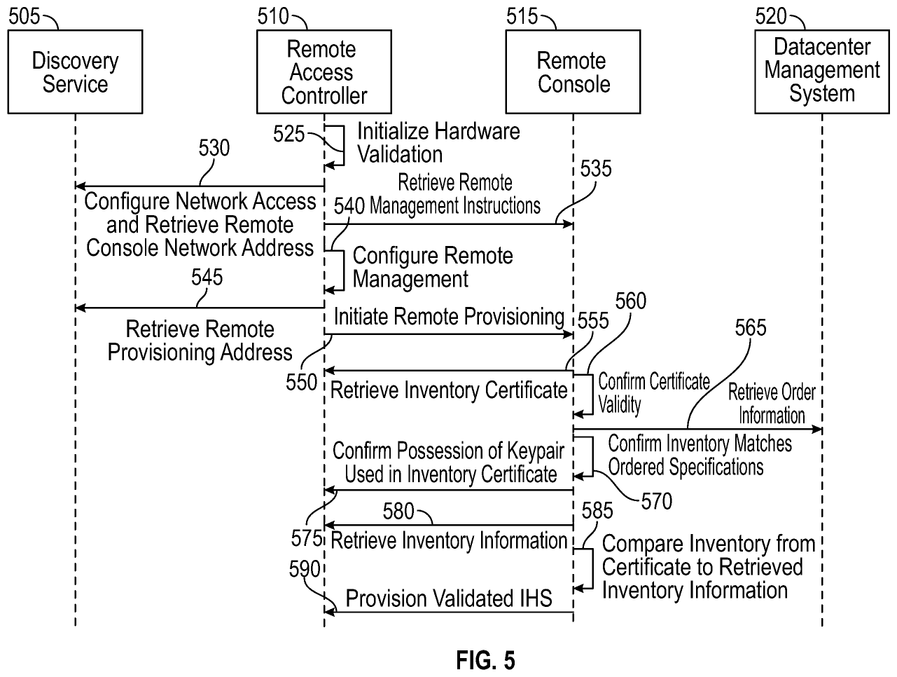

Upon delivery of the IHS, embodiments provide a customer with the capability of remotely validating that the delivered IHS includes only hardware components that were installed at the factory during manufacture of the IHS and also remotely validating that the delivered IHS conforms to specifications provided by the customer for the manufacture of that particular IHS. Accordingly, FIG. 5 is a swim lane diagram illustrating certain responsibilities of components of a system configured according to certain embodiments for console-based validation of the secure assembly and delivery of the IHS. Embodiments may begin with the delivery of an IHS to a customer, where the IHS has been assembled and provisioned according to the procedures set forth above. In particular, the delivered IHS has been provisioned at the factory to include a signed inventory certificate that specifies the factory installed hardware components of the IHS. In addition, the delivered IHS has been configured to initiate procedures that will configure remote provisioning of the IHS upon the IHS being powered by a customer for the first time, or upon being booted with a predefined boot signal.

Upon receiving an IHS configured in this manner, the IHS may be unpacked, assembled and initialized by an administrator in order to prepare the IHS for further provisioning. At block 525, the IHS has been powered and a validation process of the IHS is initialized. In some embodiments, the validation process may run within a pre-boot environment, such as a PXE (Preboot eXecution Environment) operating environment. In some embodiments, a pre-boot operating environment in which the validation process runs may include an operating environment that is executed by the remote access controller 510 of the IHS based on validated firmware instructions. In such embodiments, the instructions of the validation process may be used to calculate a hash value that is verified to correspond to a value that was stored in an immutable memory of the IHS during its factory provisioning. In this manner, the validation process of the remote access controller 510 may be added to the root of trust of the IHS. In embodiments that utilize a pre-boot operating environment, the validation of the detected hardware components of the IHS is conducted prior to booting of the operating system of the IHS.

With the validation process of the remote access controller 510 initialized, at 530, the validation process initiates a connection with a network discovery service 505, such as a DHCP/DNS server, that is supported by the data center or other network in which the IHS will be provisioned and, in some cases, deployed by a customer. As described above, factory provisioning of an IHS according to embodiments may include loading instructions for execution by the remote access controller 510 for initiating customer provisioning of the IHS using a remote console 515. Using such instructions loaded during factory provisioning, the validation process of the remote access controller 510 may issue, at 530, one or more queries to a discovery service 505 that is supported by the customer's network. The query by the remote access controller 510 may result in the discovery service 505 issuing the network adapter utilized by the remote access controller 510 an IP address for use in further provisioning the IHS for deployment. The remote access controller 510 may also issue a DNS query to the discovery service 505 in order to request a network address associated with the customer's remote console application 515 that is used for remote provisioning of IHSs that are being incorporated into a network or data center.

Using the address information provided by the discovery service 505, at 535, the remote access controller 510 may initiate a connection with the remote console 515 in order to retrieve instructions for configuring a remote management connection with the remote console 515. In various embodiments, the remote console 515 may provide the remote access controller 510 with scripts and other instructions for use in configuring the IHS for remote management, in some cases according to a remote management protocol support by the remote console 515, such as the REDFISH remote management protocol. At 540, the remote access controller 510 utilizes these provided instructions for configuring a remote management connection with the remote console 515. In this manner, the remote access controller 510 may be factory provisioned to automatically initiate a connection with the customer's remote console 515 such that the IHS can be configured for remote management with the customer needing only to install and power the IHS.

In order to initiate remote provisioning of the IHS, at 545, the remote access controller 510 may issue a query to the discovery service 505 for the network address of a remote provisioning service that has been specified in the instructions provided to the remote access controller at 535. Using the provided network address, at 550, the remote access controller 510 announces a readiness for remote provisioning of the IHS by a provisioning service supported by the remote console 515. Prior to initiating remote provisioning of the IHS, the remote console 515 may be configured to first validate that the IHS includes only hardware components that were installed during factory assembly of the IHS, thus ensuring that the IHS has not been compromised before integrating the IHS into the customer's network. Such validation allows a customer to ensure that all of the detected hardware components of the IHS are the same components that were installed by the manufacturer of the IHS and also allows the customer to accurately confirm that the IHS conforms to the customer's specifications that were provided for the manufacture of this particular IHS.

Remote validation of the hardware components of the IHS is initiated, at 555, by the remote console 515 requesting the hardware inventory certificate stored by the remote access controller 510. As described above, the factory provisioning process may include uploading a signed inventory certificate that specifies the factory installed hardware of the IHS to a persistent memory that is accessed by the remote access controller 510. This hardware inventory certificate is retrieved by the remote access controller 510 from its stored location in a persistent memory of the IHS and is transmitted to the remote console 515. In some embodiments, the inventory certificate may instead be retrieved from a service supported by a trusted entity that provides ongoing support of the IHS and that has access to a stored inventory certificate that was generated during factory provisioning of the IHS. Upon receipt of the inventory certificate, at 560, the remote console may utilize the public key of the remote access controller 510 included in the inventory certificate to validate the integrity of the hardware inventory information that is included in the certificate against a signature that is also included in the certificate. The remote console 515 may also utilize the public key of the factory certificate authority, described with regard to FIGS. 3 and 4, in order to confirm the trustworthiness of the inventory certificate presented by remote access controller 510, and thus of remote access controller 510.

As described with regard to FIGS. 3 and 4, upon ordering an IHS for manufacture, a customer may maintain a record of the specifications for the ordered IHS. For instance, the customer may maintain a record specifying the hardware specifications for the ordered IHS, such as the processor(s), memory capacity, type of memory, the number and types of storage drives, network controllers, FPGA cards and storage controllers that are to be included in the IHS. Upon issuing an order for an IHS, a customer may store the hardware specifications for the ordered IHS in a system such as a datacenter management system 520, or in other similar repository that may be used to catalog the IHSs that have been ordered by the customer and that are in use by a customer.

At 570, the remote console 515 parses the hardware inventory information from the signed inventory certificate and compares this inventory of the factory installed hardware of the IHS against the specifications that were provided by the customer for the manufacture of this IHS. Any identified discrepancies may be presented to an administrator via remote console 515 and an administrator may be provided with capabilities for halting any further provisioning of the IHS, or to continue with the validation of the detected hardware of the IHS. In some instances, an administrator may choose to investigate and resolve any identified discrepancies prior to continuing provisioning of the IHS. In other instances, the administrator may choose to accept any discrepancies, such as inconsequential discrepancies or the IHS being manufactured with components that are superior to those that were ordered, and to continue with the validation and provisioning of the IHS.

As indicated in FIG. 5, in some embodiments, at 575, the remote console 515 may further validate the trustworthiness of remote access controller 510 before proceeding with the validation of the hardware components reported by remote access controller 510. In some embodiments, the remote console 515 may present a proof of possession token to the remote access controller 510, where the token is encoded using public key of the remote access controller 510 that is included in the inventory certificate. The remote access controller 510 utilizes the private key from the keypair associated with the inventory certificate in order to recover the encoded information included in the token. By presenting the recovered token information to the remote console 515, the remote access controller 510 demonstrates proof of the private key associated with the inventory certificate and provides assurances of the authenticity of information provided by remote access controller 510.

If the remote access controller 510 has been deemed trustworthy and the inventory of factory installed hardware components of IHS has been confirmed to match the customer's specifications or has otherwise been approved via the remote console 515, a request for an inventory of detected hardware components may be issued, at block 580, to the remote access controller 510. In response to the inventory request from the remote console 515, the validation process of the remote access controller 510 may collect an inventory of the detected hardware components of the IHS. In some instances, this collection of inventory information may be initiated earlier by the validation process, such as during initialization of the IHS. As describe with regard to FIG. 2, the remote access controller 510 may interface with various managed hardware components of the IHS. As such, the remote access controller 510 may be configured to utilize its sideband signaling capabilities in order to collect an inventory of the managed hardware components of the IHS. The validation process of the remote access controller 510 may also query the BIOS of the IHS for an inventory of hardware components that have been detected by BIOS. The validation process may also retrieve additional hardware inventory information from a Trusted Platform Module (TPM) of the IHS. The validation process may also retrieve additional inventory information from other data sources, such as directly from the processor of the IHS or from a chassis management controller of a chassis in which the IHS has been installed.

Upon receipt of the collected inventory of the detected hardware components of the IHS, at 585, a remote validation process of the remote console 515 compares the collected inventory information against the inventory information that is parsed from the signed inventory certificate. Accordingly, the remote validation process may confirm the identity of the detected TPM against the identity of the TPM reported in the signed inventory certificate. If the identity of the TPM is not validated, the remote validation process may signal a core inventory validation failure since any discrepancies between the identity of the factory installed TPM and the TPM that has been detected in the initialized IHS signals a potential compromise in the root of trusted hardware components of the IHS. The remote validation process may similarly confirm the identity of the detected remote access controller 510 against the identity of the remote access controller reported in the signed inventory certificate. If the remote access controller 510 is not validated, the remote validation process may signal a core inventory validation failure. As with the TPM, any discrepancies between the identity of the factory installed remote access controller and the remote access controller 510 detected in the initialized IHS signals a potential compromise of the root of trust of the IHS.

The remote validation process of the remote console 515 may continue the comparison of the detected hardware components of the initialized IHS against the identities of the factory installed hardware components that are included in the signed inventory certificate. If the unique identifiers of the detected hardware components of the initialized IHS match the identifiers of the factory installed hardware components from the signed inventory certificate, at 590, the remote validation process may signal a successful validation of the detected hardware of the IHS and may initiate remote provision of the IHS. The customer receiving delivery of the IHS is thus assured that, prior to incorporating the delivered IHS into their network, the IHS is operating using only hardware components that were installed at the factory during manufacture of the IHS.

If any discrepancies are detected between the detected hardware components of the initialized IHS and the hardware components reported in the signed inventory certificate, a partial validation of the hardware inventory of the IHS may be reported. In some instances, such discrepancies may result from failure to detect hardware components that are identified in the signed inventory certificate. In some instances, such discrepancies may result from mismatched identity information between the detected hardware components and the components listed in the signed inventory certificate, such as discrepancies in the serial numbers or other unique identifiers associated with a hardware component. In other instances, such discrepancies may result from the detection of hardware components that are not present in the signed inventory certificate. In all cases, any such discrepancies may be reported, thus allowing an administrator to investigate further.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for remote validation of the secure assembly and delivery of an IHS (Information Handling System), the method comprising:
initiating, by a validation process of the IHS, a remote management connection with a remote management console;
retrieving, by the remote management console, an inventory certificate generated during factory provisioning of the IHS, wherein the inventory certificate includes an inventory identifying a plurality of hardware components installed during factory assembly of the IHS;
retrieving, by the remote management console, an inventory of detected hardware components of the IHS; and
comparing, by the remote management console, the collected inventory of detected hardware components of the IHS against the inventory from the inventory certificate in order to validate the detected hardware components of the IHS as the same hardware components installed during factory assembly of the IHS.

2. The method of claim 1, further comprising: comparing, by the remote management console, the inventory included in the inventory certificate against specifications provided for the manufacture of the IHS in order to validate the IHS has been assembled to include specified hardware components.

3. The method of claim 1, wherein the validation process of the IHS comprises a pre-boot process implemented by a remote access controller of the IHS.

4. The method of claim 1, wherein the remote management connection with the remote console is automatically initiated by the validation process of the IHS according to instructions uploaded to the IHS during the factory provisioning of the IHS.

5. The method of claim 1, further comprising: confirming, by the remote management console, an integrity of the inventory included in the inventory certificate against a signature included in the inventory certificate.

6. The method of claim 5, further comprising: confirming, by the remote management console, that the validation process of the IHS has access to a private key used to generate the signature.

7. The method of claim 1, wherein the comparison of the collected inventory of detected hardware components of the IHS against the inventory from the inventory certificate identifies any discrepancies between the detected hardware components of the IHS and the hardware components installed during factory assembly of the IHS.

8. The method of claim 1, wherein the remote management console supports remote administration of a plurality of IHSs operating within a data center.

9. An IHS (Information Handling System) comprising:
a plurality of hardware components, wherein during factory provisioning of the IHS an inventory certificate is uploaded to the IHS, wherein the inventory certificate includes an inventory that identifies a plurality of hardware components installed during factory assembly of the IHS, and wherein the plurality of hardware components comprise:
one or more processors; and
one or more memory devices coupled to the processors, the memory devices storing computer-readable instructions that, upon execution by the processors, cause a validation process of the IHS to:
initiate a remote management connection with a remote management console;
transmit the inventory certificate uploaded to the IHS during factory provisioning of the IHS to the remote management console; and
transmit an inventory of the plurality of hardware components of the IHS to the remote management console, wherein the remote management console compares the transmitted inventory of hardware components of the IHS against the inventory from the inventory certificate in order to validate the plurality of hardware components of the IHS as the same hardware components installed during factory assembly of the IHS.

10. The IHS of claim 9, where the remote management console further compares the inventory included in the inventory certificate against specifications provided for the manufacture of the IHS in order to validate the IHS has been assembled to include specified hardware components.

11. The IHS of claim 9, wherein the validation process of the IHS comprises a pre-boot process implemented by a remote access controller of the IHS.

12. The IHS of claim 9, wherein the remote management connection with the remote console is automatically initiated by the validation process of the IHS according to instructions uploaded to the IHS during the factory provisioning of the IHS.

13. The IHS of claim 9, wherein the remote management console confirms an integrity of the inventory included in the inventory certificate against a signature included in the inventory certificate.

14. The IHS of claim 13, wherein the remote management console confirms that the validation process of the IHS has access to a private key used to generate the signature.

15. The IHS of claim 9, wherein the remote management console supports remote administration of a plurality of IHSs operating within a data center.

16. A system for remote validation of the secure assembly and delivery of an IHS (Information Handling System), the system comprising:
the IHS, wherein during factory provisioning of the IHS an inventory certificate is generated that includes an inventory that identifies a plurality of hardware components installed during factory assembly of the IHS, and wherein a validation process of the IHS initiates a remote management connection with a remote management console; and
the remote management console configured to:
retrieve the inventory certificate generated during factory provisioning of the IHS;
retrieve, from the IHS, an inventory of detected hardware components of the IHS; and
compare the collected inventory of detected hardware components of the IHS against the inventory from the inventory certificate in order to validate the detected hardware components of the IHS as the same hardware components installed during factory assembly of the IHS.

17. The system of claim 16, wherein the remote management console is further configured to compare the inventory included in the inventory certificate against specifications provided for the manufacture of the IHS in order to validate the IHS has been assembled to include specified hardware components.

18. The system of claim 16, wherein the inventory certificate is retrieved from a persistent memory of the IHS or from a remote storage.

19. The system of claim 16, wherein the remote management connection with the remote console is automatically initiated by the validation process of the IHS according to instructions uploaded to the IHS during the factory provisioning of the IHS.

20. The system of claim 16, wherein the remote management console supports remote administration of a plurality of IHSs operating within a data center.
